(19) United States
(12) Patent Application Publication
(10) Pub. No.: US 2020/0302554 A1
(43) Pub. Date: Sep. 24, 2020

(54) TEMPERATURE AND RAINFALL MODELING FOR CROP MANAGEMENT

(71) Applicant: International Business Machines Corporation, Armonk, NY (US)

(72) Inventors: Livia Elanor Stacey, Basingstoke (GB); David Alec Selby, Fareham (GB)

(21) Appl. No.: 16/360,202

(22) Filed: Mar. 21, 2019

(51) Int. Cl. G06Q 50/02; G06F 17/50; G06Q 10/06; G06N 20/20

(52) U.S. Cl. CPC G06Q 50/02; G06N 20/20; G06Q 10/0637; G06F 17/5009

(57) ABSTRACT

Temperature and Rainfall modeling for crop management in a geographical space are presented. One example includes obtaining rainfall information and temperature information for a geographic area, wherein the geographic area includes the geographical space. A model representing a relationship between rainfall and ambient temperature for the geographic area is generated based on the obtained rainfall information and temperature information. A temperature threshold for the geographical space is determined based on the generated model, where the temperature threshold is for identifying a crop planting or production condition.

### BACKGROUND

The present disclosure relates generally to the agricultural production, and more particularly to a method for crop management in a geographical space.

Weather is a key source of uncertainty affecting crop yield. Accurate modeling of multivariate weather distributions may allow farmers to make better decisions for reducing their exposure to weather risk or take advantage of favorable climatic conditions. However, many variables relevant to weather may have a large effect on crop yield.

### SUMMARY

According to an aspect of the present disclosure there is provided computer-implemented method for crop management in a geographical space. The method includes obtaining rainfall information relating to sensed rainfall for a geographic area within a time period, the geographic area including the geographical space. The method also includes obtaining temperature information relating to sensed ambient temperature for the geographic area within the time period. The method further includes generating a model based on the obtained rainfall information and temperature information, the model representing a relationship between rainfall and ambient temperature for the geographic area. The method also includes determining a temperature threshold for the geographical space based on the generated model, the temperature threshold being for identifying a crop planting or production condition.

According to another aspect of the disclosure, there is provided a computer program product for crop management in a geographical space. The computer program product comprises a computer readable storage medium having program instructions embodied therewith, the program instructions executable by a processing unit to cause the processing unit to perform a method according to a proposed embodiment.

According to yet another aspect of the disclosure, there is provided a system for crop management in a geographical space. The system comprises an interface configured to obtaining rainfall information relating to sensed rainfall for a geographic area within a time period, the geographic area including the geographical space. The interface is also configured to obtain temperature information relating to sensed ambient temperature for the geographic area within the time period. The system also comprises a modeling unit configured to generate a model based on the obtained rainfall information and temperature information, the model representing a relationship between rainfall and ambient temperature for the geographic area. The system further includes a data processing unit configured to determine a temperature threshold for the geographical space based on the generated model, the temperature threshold being for identifying a crop planting or production condition.

### BRIEF DESCRIPTION OF THE DRAWINGS

Preferred embodiments of the present disclosure will now be described, by way of example only, with reference to the following drawings, in which:

FIG. 1 depicts a pictorial representation of an example distributed system in which aspects of the illustrative embodiments may be implemented.

FIG. 2 is a block diagram of an example system in which aspects of the illustrative embodiments may be implemented.

FIG. 3 is a simplified block diagram of an example embodiment of a system for crop management in a geographical space according to an embodiment.

FIGS. 4 is a flow diagram of a method for crop management in a geographical space according to an embodiment.

FIG. 5 illustrates a system according to another embodiment.

### DETAILED DESCRIPTION

It should be understood that the Figures are merely schematic and are not drawn to scale. It should also be understood that the same reference numerals are used throughout the Figures to indicate the same or similar parts.

In the context of the present application, where embodiments of the present disclosure constitute a method, it should be understood that such a method may be a process for execution by a computer (e.g., a computer-implemented method). The various steps of the method may therefore reflect various parts of a computer program, e.g. various parts of one or more algorithms

Also, in the context of the present application, a system may be a single device or a collection of distributed devices that are adapted to execute one or more embodiments of the methods of the present disclosure. For instance, a system may be a personal computer (PC), a server, or a collection of PCs and/or servers connected via a network such as a local area network, the Internet and so on to cooperatively execute at least one embodiment of the methods of the present disclosure.

It is proposed that, among variables relevant to weather, rainfall and temperature are two important factors which may have a significant effect on crop yield and/or crop quality. Typically, temperature affects the length of the growing season and rainfall affects plant production (e.g. leaf area and the photosynthetic efficiency). Accordingly, the present disclosure proposes that accurate modeling/simulation of relationships between temperature and rainfall for a geographic area may be beneficial for agricultural production.

A geographical space for crop production (e.g. one or more crop fields) may be limited in size with respect to a larger geographic area (e.g. district, county, state or country). Thus, although information regarding sensed rainfall for a larger geographic area may be available, accurate information about sensed rainfall for a limited geographic space may be unavailable or limited.

The same may hold for temperature information relating to sensed ambient temperature for a limited geographic space and a larger geographic area. In other words, although information regarding sensed ambient temperature for a larger geographic area may be available, accurate information about sensed ambient temperature for a limited geographic space may be unavailable or limited. However, due to available temperature sensing/monitoring technology, this may not necessarily be the case, thus meaning accurate information about sensed ambient temperature for a limited geographic space may be easily and/or widely available (whereas rainfall information for the same limited geographic space may not be).

Accordingly, reliance on rainfall information and temperature information for a limited geographic space may make it difficult to establish an interdependence (e.g., correlation) between rainfall and temperature for the limited geographic space.

Embodiments of the present disclosure utilize rainfall information relating to sensed rainfall for a geographic area (e.g., a larger area such as a town, city, state, etc.) and temperature information relating to sensed ambient temperature for the geographic area. Such rainfall and temperature information may be easily obtainable, because it is not limited to a restricted geographical space within the geographic area, for example. Based on such information, a model representing a relationship between rainfall and ambient temperature for the geographic area may be generated. Using such a model, a temperature threshold identifying a crop planting or production condition for a limited/restricted geographical space within the geographic area may then be determined.

By using rainfall and temperature information that is widely or easily obtainable for a larger geographic area, an interdependence (e.g., correlation) between rainfall and temperature for the larger geographic area may be identified. From this, an inference for a limited geographic space within the larger geographic area may be made. For instance, it may be inferred that the established interdependence between rainfall and temperature for the larger geographic area applies equally to a limited geographic space within the larger geographic area. Additionally, or alternatively, it may be inferred that the established interdependence between rainfall and temperature for the larger geographic area applies equally to a limited geographic space within larger geographic area, but with slight adjustment or modification to account for other factors (such as soil type, crop type, geographic features, etc.).

Embodiments may facilitate the generation of a model representing a relationship between rainfall and ambient temperature for a geographic area. This may, in turn, help to determine a temperature that has a related value of rainfall that is preferable for crop planting or production in a geographical space of the geographic area. Embodiments may therefore assist in identifying a temperature condition for a geographic space within geographic area that may obtain a required or optimal crop.

A tool for enabling crop management systems to infer preferred planting or productions conditions within a geographical space may therefore be provided by a proposed embodiment. This may be used to manage crop planting and/or positioning. This may facilitate assessment of crop planting/production conditions for a geographical space over a temporal duration. For example, a temperature threshold at which rainfall meets a predetermined requirement may be identified. Comparison of sensed temperature for a geographical space against the temperature threshold may then be undertaken to identify an optimal time to plant a particular crop in the geographical space. Embodiments may therefore cater to crop requirements for localized environmental constraints and optimizers, which may change dynamically with respect to time and/or location.

By way of example, proposed embodiments may generate a model based on obtained rainfall information and temperature information for a geographic area. The model may describe a variation of rainfall in the geographic area with respect to ambient temperature within the geographic area. The generated model may then be used to determine preferred temperatures with respect to locations within the geographic area, and this information may in turned be used to instruct users (e.g. individuals with portable communication devices) when to plant a crop (e.g., when the average sensed ambient temperature over a predetermined period of time exceeds a temperature that has a related rainfall exceeding a known/established requirement for the crop) within a geographical space of the geographic area. In some embodiments, determined temperature thresholds with respect to locations within the geographic area may be used to determine how best to locate crops (e.g., so as to ensure each crop is exposed to a required rainfall amount).

Proposed embodiments may thus provide a concept for suggesting localized temperature considerations to facilitate optimized crop planting or production within a geographical space. For example, if a first crop requires a first amount of rainfall, an embodiment may be used to identify that the first crop should not be planted in a particular geographical space or location until the average sensed ambient temperature for that space/location exceeds a first temperature (that a model indicates as being associated with rainfall amount exceeding the first amount of rainfall).

Accordingly, proposed embodiments may provide a tool for assisting in the determination as to what impact temperatures within a geographic space may have with respect to quality of crop planting or crop production conditions. This may help to improve an understanding of how crops may be optimally arranged or planted at one or more geographic spaces within a larger geographic area, thus ensuring adequate or optimal crop yield, for example.

Proposed embodiments may be configured to use a model to determine an ambient temperature value that the model indicates has a related value of rainfall adhering to a predetermined requirement. Such a requirement may be crop-specific. For instance, ideal ground conditions for planting may be different for different crops. Embodiments may therefore be useful for a wide range of crop types, because they may take into account crop-specific requirements when using a generated model to determine a preferred ambient temperature value. As an example, one crop-type might be sensitive to the ground being too wet at planting, whereas another crop-type may just want as much rainfall as possible. The predetermined requirement would therefore be different, but the model would still allow for an estimate of rainfall to be obtained based on temperature and whether the requirement is met. Such information may then be used to identify when and/or how crops should be planted within a geographical space to improve or optimize crop production.

Reference to a geographical space is to be taken to refer to a limited geographical area within which a crop may be planted within a larger geographic area. A geographical space may therefore be thought of as an area that, although it can be described using a single location identifier or label (e.g., field name, postal code/zip code, street, field, or other identifier), may comprise a plurality of locations or positions that may be defined/or identified within the geographical space. Accordingly, in embodiments, a geographical space may be described or identified using a geofence. Also, a geographical space may be time dependent, time varying and/or have an existence that is finite with respect to time. For example, a geographical space may be associated with (and even described with reference to) a particular crop type and this may change season-to-season and/or year-to-year. A geographical space may therefore be defined by the boundary of a crop, and may thus consist of one or more fields or crop planting lots.

Embodiments may, for example, enable a crop management system to infer rainfall for a field (or group of fields) from a sensed ambient temperature at the field (or fields). Further, assessment or management of crop production over a temporal period may be enabled. Embodiments may therefore be particularly useful for crop production within a bounded area that extends across one or more fields (but not to an area the size of which rainfall information is easily or widely obtainable for). Rainfall information for a larger geographic area may be leveraged to establish a relationship between rainfall and ambient temperature for a smaller geographical space (within the geographic area) which would otherwise not be possible (e.g., if trying to rely on rainfall information for the smaller geographical space). Using such a relationship, combined with an understanding of rainfall requirements for a crop, temperature requirements for the smaller geographical space to (e.g., to ensure required rainfall) may be inferred. With such temperature requirements identified, along with real-time information about sensed ambient temperature within the bounded area, suggestions as to when a crop should be planted may be established.

Embodiments may include identifying a model of how rainfall varies with ambient temperature for a geographical space. This may be achieved by analyzing rainfall information and temperature information for a larger geographic area that contains the geographical space.

Embodiments may facilitate the efficient and effective provision of crop planting/production guidance for a geographical space. Such guidance may be based on modeling rainfall and temperature variations for a larger geographic area (for which more information may be available).

Illustrative embodiments may provide for analyzing and identifying links between rainfall and temperature for a broader geographic area so as to infer a relationship between rainfall and temperature for a geographical space within the geographic area, and may account for changes over time. Dynamic crop planting and/or crop management concepts may therefore be provided by proposed embodiments.

Modifications and additional steps to a traditional crop management system may also be proposed which may enhance the value and utility of the proposed concepts.

In some embodiments, generating a model may comprise analyzing the obtained rainfall information and temperature information to determine a correlation between rainfall for the geographic area and ambient temperature for the geographic area. One or more functions for describing the determined correlation between rainfall for the geographic area and ambient temperature for the geographic area may then be determined. A model representing a relationship between rainfall and ambient temperature for the geographic area may then be generated based on the one or more functions. Over larger geographical spaces and/or time periods, a single function may be computed to avoid the need for highly granular individual models specific to locations.

For instance, analyzing the obtained rainfall information and temperature information may comprise processing the obtained rainfall information and temperature information with one or more machine learning algorithms to determine a correlation between rainfall for the geographic area and ambient temperature for the geographic area. Embodiments may therefore employ artificial intelligence and/or machine learning techniques for processing the rainfall information and temperature information. This may facilitate simple and/or cheap implementation of embodiments. Regression techniques covering the relationship between two continuous variables may be appropriate, for example. However, it is noted that a relationship may be non-linear, and so this may be consideration in selection of an appropriate analysis process.

Some embodiments may further comprise obtaining information indicative of a detected ambient temperature for the geographic space, and detecting a crop planting or production condition for the geographical space based on the detected ambient temperature for the geographic space and the temperature threshold. Embodiments may therefore be adapted to indicate when a crop planting or production condition is met. This may facilitate quick and simple identification of crop planting conditions for improved crop yield.

For example, embodiments may be adapted to output a signal indicative of the detected crop planting or production for the geographical space.

In some embodiments, obtaining information indicative of a detected ambient temperature for the geographic space may comprise obtaining at least one of a control signal from a user or control system and a sensor output signal from a temperature sensor. Embodiments may therefore cater to different ways in which information about detected ambient temperature may be provided. This may provide additional flexibility and enable more accurate temperature information to be obtained and used.

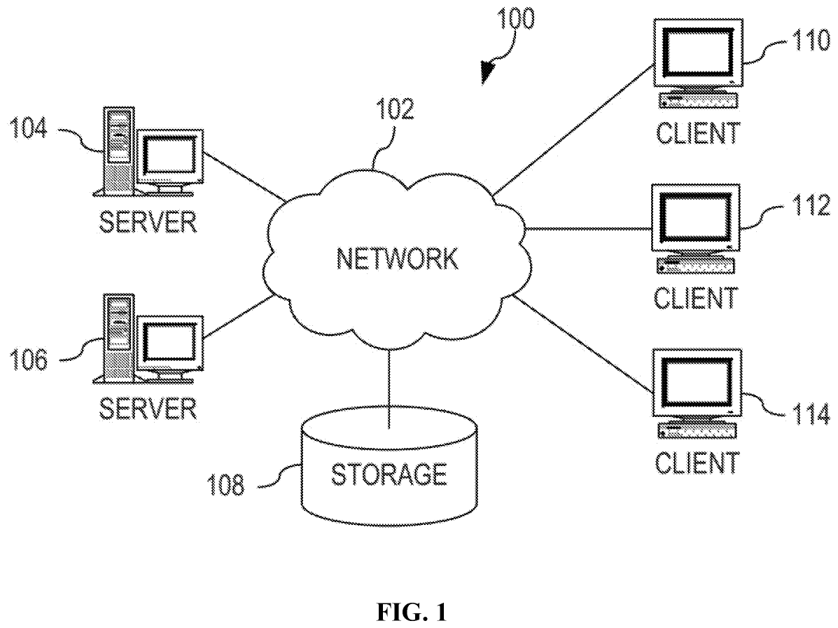

FIG. 1 depicts a pictorial representation of an example distributed system 100 in which aspects of the illustrative embodiments may be implemented. Distributed system 100 may include a network of computers in which aspects of the illustrative embodiments may be implemented. The distributed system 100 contains at least one network 102, which is the medium used to provide communication links between various devices and computers connected together within the distributed system 100. The network 102 may include various connection media, such as cable wire, wireless communication links, or fiber optic cables.

In the depicted example, a first server 104 and second server 106 are connected to the network 102 along with a storage unit 108. In addition, clients 110, 112, and 114 are also connected to the network 102. Clients 110, 112, and 114 may be, for example, personal computers, network computers, or the like. In the depicted example, the first server 104 provides data, such as boot files, operating system images, and applications to clients 110, 112, and 114. Clients 110, 112, and 114 may be clients to the first server 104 in the depicted example. The distributed system 100 may include additional servers, clients, and other devices (not shown).

In the depicted example, the distributed system 100 may be the Internet with the network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, the distributed system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present disclosure, and therefore, the particular elements shown in FIG. 1 should not be considered limiting with regard to the environments in which the illustrative embodiments of the present disclosure may be implemented.

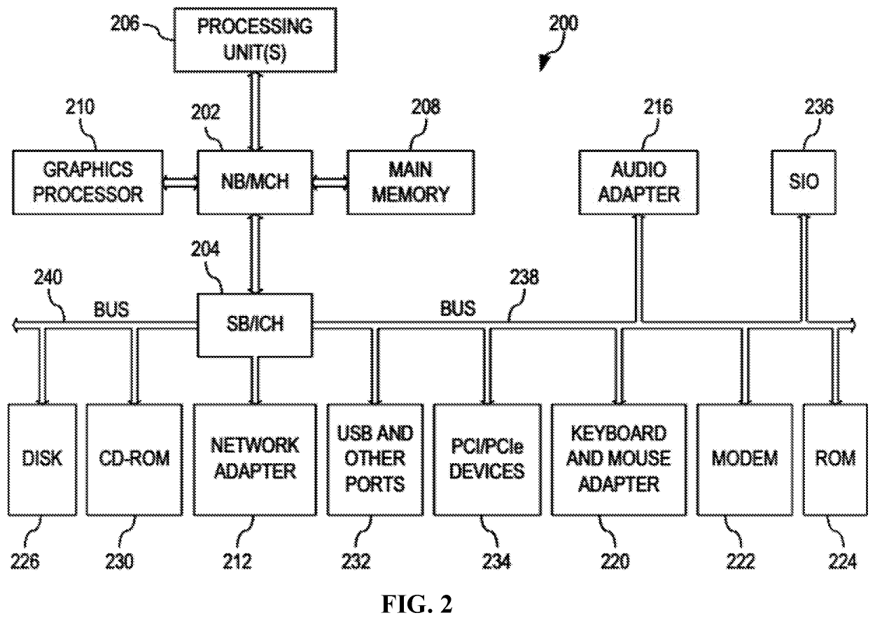

FIG. 2 is a block diagram of an example system 200 in which aspects of the illustrative embodiments may be implemented. The system 200 is an example of a computer, such as client 110 in FIG. 1, in which computer-usable code or instructions implementing the processes for illustrative embodiments of the present disclosure may be located.

In the depicted example, the system 200 employs a hub architecture including a north bridge and memory controller hub (NB/MCH) 202 and a south bridge and input/output (I/O) controller hub (SB/ICH) 204. A processing unit 206, a main memory 208, and a graphics processor 210 are connected to NB/MCH 202. The graphics processor 210 may be connected to the NB/MCH 202 through, for example, an accelerated graphics port (AGP).

In the depicted example, a network adapter 212 connects to SB/ICH 204. An audio adapter 216, a keyboard and a mouse adapter 220, a modem 222, a read only memory (ROM) 224, a hard disk drive (HDD) 226, a CD-ROM drive 230, a universal serial bus (USB) ports and other communication ports 232, and PCI/PCIe devices 234 connect to the SB/ICH 204 through first bus 238 and second bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

The HDD 226 and CD-ROM drive 230 connect to the SB/ICH 204 through second bus 240. The HDD 226 and CD-ROM drive 230 may use, for example, an integrated drive electronics (IDE) or a serial advanced technology attachment (SATA) interface. Super I/O (SIO) device 236 may be connected to SB/ICH 204.

An operating system runs on the processing unit 206. The operating system coordinates and provides control of various components within the system 200 in FIG. 2. As a client, the operating system may be a commercially available operating system. An object-oriented programming system, such as the Java™ programming system, may run in conjunction with the operating system and provides calls to the operating system from Java™ programs or applications executing on system 200.

As a server, system 200 may be, for example, an IBM® eServer™ System p® computer system, running the Advanced Interactive Executive (AIX®) operating system or the LINUX® operating system. The system 200 may be a symmetric multiprocessor (SMP) system including a plurality of processors in processing unit 206. Alternatively, a single processor system may be employed.

Instructions for the operating system, the programming system, and applications or programs are located on storage devices, such as HDD 226, and may be loaded into main memory 208 for execution by processing unit 206. Similarly, one or more message processing programs according to an embodiment may be adapted to be stored by the storage devices and/or the main memory 208.

The processes for illustrative embodiments of the present disclosure may be performed by processing unit 206 using computer usable program code, which may be located in a memory such as, for example, main memory 208, ROM 224, or in one or more peripheral devices 226 and 230.

A bus system, such as first bus 238 or second bus 240 as shown in FIG. 2, may comprise one or more buses. Of course, the bus system may be implemented using any type of communication fabric or architecture that provides for a transfer of data between different components or devices attached to the fabric or architecture. A communication unit, such as the modem 222 or the network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the system mentioned previously, without departing from the spirit and scope of the present disclosure.

Moreover, the system 200 may take the form of any of a number of different data processing systems including client computing devices, server computing devices, a tablet computer, laptop computer, telephone or other communication device, a personal digital assistant (PDA), or the like. In some illustrative examples, the system 200 may be a portable computing device that is configured with flash memory to provide non-volatile memory for storing operating system files and/or user-generated data, for example. Thus, the system 200 may essentially be any known or later-developed data processing system without architectural limitation.

A proposed concept may enhance a wireless mobile communication system by providing instructions for an individual to move to a target location within a geographical space. Embodiments may provide such instructions by analyzing a model describing a variation of communication bandwidth density in the geographical space with respect to location and time. Such a model may be generated in consideration of information relating to movement of individuals in a crowd within geographical spaces and information relating to one or more activities of interest to a user in the geographical space.

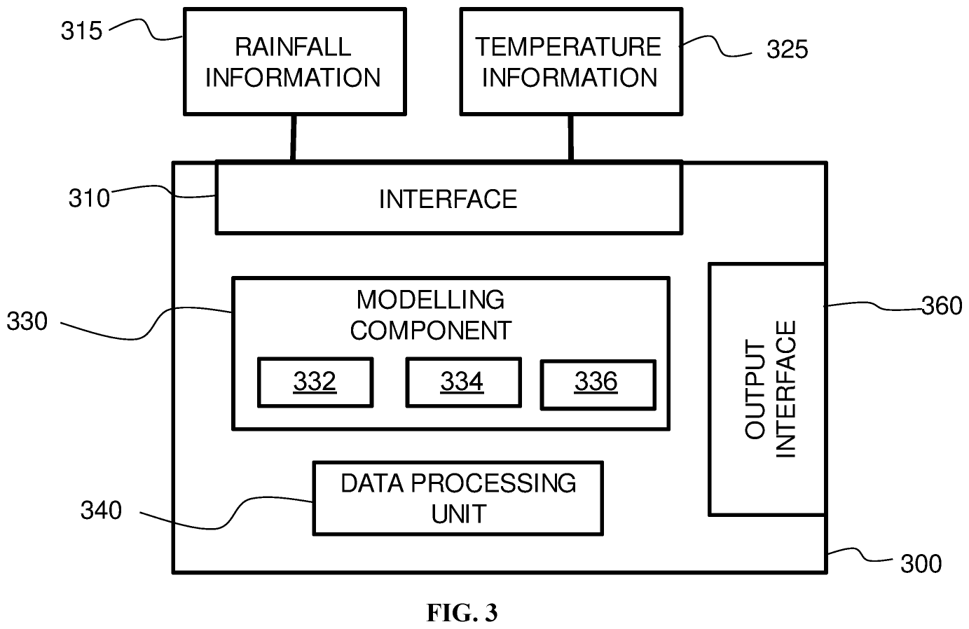

FIG. 3 is a simplified block diagram of an example embodiment of a system 300 for crop management in a geographical space. Here, the geographical space is a subspace/subarea of a geographic area. For instance, the geographical space comprises a field for a crop, and the geographic area comprises a town or county including the field.

The system 300 comprises an interface 310 (e.g., an input interface) configured to obtain rainfall information 315 relating to sensed rainfall for the geographic area within a time period. The interface 310 is also configured to obtain temperature information 325 relating to sensed ambient temperature for the geographic area within the time period. Such information may, for example, be retrieved from a (local or remotely located) data storage unit (e.g., database) that is provisioned with information from rainfall and temperature sensors. For example, the system of this embodiment employs rainfall information detailing inches (or other units of measurement) of rain per day and daily minimum night-time temperature for the geographic area. Here, it is also noted that although the time period may be of any suitable length, it is envisaged time periods longer than weekly (e.g., monthly, yearly, etc.) may be less preferable for crop planting recommendations (but potentially more relevant to climatic modeling).

It will be appreciated that other embodiments may employ other forms of rainfall and temperature information. For instance, rainfall information may comprise data about rainfall such as: inches per week; average rainfall per day; peak/maximum daily rainfall per month, etc. Similarly, temperature information may comprise data about ambient temperature such as: maximum/minimum daily temperature; average daytime temperature; maximum/minimum/average temperature variation per day; peak/maximum daily temp per month, etc. In this regard, it is noted that it may be preferable to account for data granularity (e.g., daily temperature readings may be aggregated to a weekly level for analysis in combination with weekly rainfall measurements).

A modeling component 330 of the system 300 is configured to generate a model based on the obtained rainfall information and temperature information. The model is configured to represent a relationship between rainfall and ambient temperature for the geographic area.

More specifically, in this example embodiment, the modeling component 330 comprises a data analysis unit 332 that is configured to analyze the obtained rainfall information and temperature information to determine a correlation between rainfall for the geographic area and ambient temperature for the geographic area. In particular, the data analysis unit 332 is configured to process the obtained rainfall information and temperature information with one or more machine learning algorithms to determine a correlation between rainfall for the geographic area and ambient temperature for the geographic area.

In particular, this example embodiment takes the obtained readings for temperature and rainfall and plots them against each other. A linear regression technique may be used to determine a statistical relationship between the two, and then that function may be used to fill in rainfall readings for sections of time when those readings were absent but temperature readings were present. In areas where rainfall readings were entirely absent or insufficient, an approach based on the similarity (e.g., where similarity could cover terrain type, location, elevation etc.) of an area to an area of known temp-rainfall function could be used to determine—this is where machine learning algorithms may be employed, for example.

The modeling component 330 also comprises a function generator 334 that is configured to determine one or more functions for describing the determined correlation between rainfall for the geographic area and ambient temperature for the geographic area. A model generator 336 of the modeling component is then configured to generate a model representing a relationship between rainfall and ambient temperature for the geographic area based on the one or more functions determined by the function generator 334. Here, conventional regression techniques are employed, although it will be understood the various known function identification techniques may be employed by other embodiments.

The system 300 also comprises a data processing unit 340 that is configured to determine a temperature threshold for the geographical space based on the generated model. Here, the temperature threshold is determined so that it identifies a crop planting or production condition. More specifically, the data processing unit 340 is configured to determine an ambient temperature value that the model indicates has a related value of rainfall which meets a predetermined requirement for the crop (such as minimum required rainfall or optimal rainfall, for example). Such requirements may be crop-specific. By way of example, it is possible that optimal crop production for a given crop may be achieved when the rainfall exceeds a certain daily average over the course of a month. Using this information, the model can be used to identify the temperature which is related to that daily average rainfall amount. The identified temperature can then be used as the temperature threshold.

An output interface 360 of the system 300 is configured to instruct a user about the temperature threshold. For instance, the output interface 360 is configured to communicate instructions to the user advising him/her of the temperature threshold. In this way, a user is advised as to when the crop should be planted in the geographical space (e.g., by identifying a temperature at which the geographical space should be for a specified time period prior to crop planting).

Thus, considering an example use-case of planning the planting of a crop in a specific field, it will be appreciated that the system 300 of FIG. 3 may provide for the identification of an optimized crop planting time to ensure maximal crop quality and/or yield.

It is proposed that, over a limited geographical space (x), rainfall can be derived as a function of temperature, such that:

flₓ: temperature→rainfall (i)

In a restricted space/area, this may enable temperature measurements to be used as a proxy for rainfall where rainfall data may be absent for the restricted space/area. For instance, while temperature measurements may be easily obtainable for a limited geographical space, rainfall information for the same limited geographical space may be much harder to gather (and is therefore more likely to be partially absent). Using a relationship determined for rainfall and temperature information data that is available for a larger geographic area can be leveraged to generate a model, which can then in turn be used for a more limited geographical space within the larger geographic area.

For large datasets covering large geographic areas, machine learning techniques and processes may be used be used to determine the relationship(s) between temperature and rainfall across the geographic area. Embodiments may therefore generate a single model without having to compute multiple relationships in order to apply a model across an extended area or to apply a model throughout a whole year rather than determining the relationship in each season.

It is to be understood that the example implementations detailed above are examples of many possible implementations that may be employed to manage crop planting and/or production in a geographical space. Accordingly, there are many other potential implementations that could also be used.

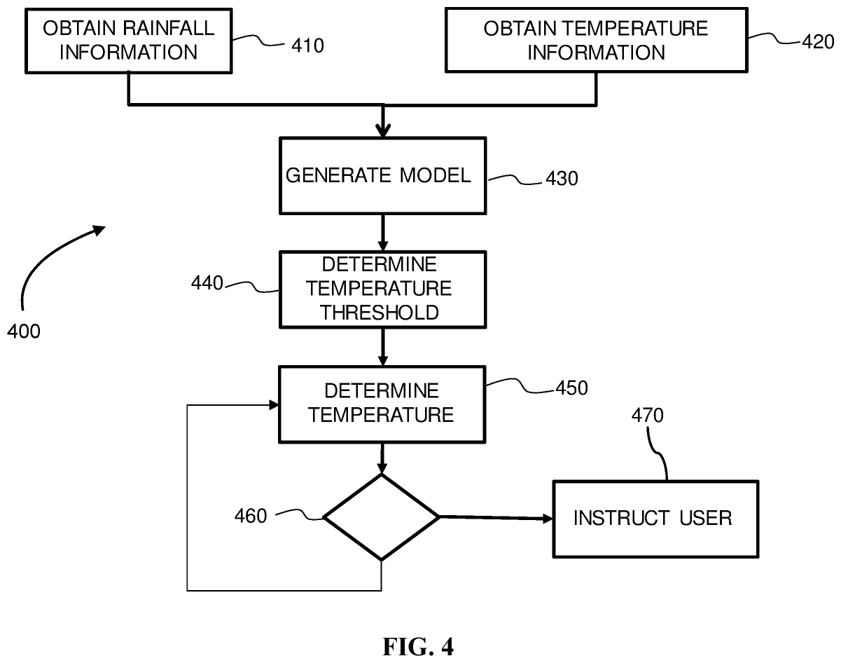

Referring now to FIG. 4, there is depicted a flow diagram of a computer-implemented method 400 for crop management in a geographical space according to an embodiment. In this example, the geographical space is defined by the boundary of a crop to be planted and substantially matches that of a field or plot of agricultural land.

Step 410 comprises obtaining rainfall information relating to sensed rainfall for a geographic area within a time period. Here, the geographic area may be, for example, a town within which the geographical space of the field/plot is situated. In this way, the geographic area may be larger than, and includes, the geographical space. Example rainfall information obtained may include measured values of daily rainfall for the town (e.g., inches or millimeters of rain per day) for a time period of months or years.

Step 420 comprises obtaining temperature information relating to sensed ambient temperature for the geographic area within the time period. Example temperature information obtained may thus include measured average and/or peak temperature per day for the town (e.g., degrees Celsius) for a time period of months or years.

In step 430 a model is generated based on the obtained rainfall information and temperature information. The model is configured to represent relationship between rainfall and ambient temperature for the geographic area.

By way of example, in this embodiment, step 430 comprises analyzing the obtained rainfall information and temperature information to determine a correlation between rainfall for the geographic area and ambient temperature for the geographic area. More specifically, analyzing the obtained rainfall information and temperature information may comprise processing the obtained rainfall information and temperature information with one or more machine learning algorithms to determine a correlation between rainfall and ambient temperature for the geographic area. Step 430 may also comprise determining one or more functions for describing the determined correlation between rainfall and ambient temperature for the geographic area and generating a model representing a relationship between rainfall and ambient temperature for the geographic area, based on the one or more functions.

Based on the generated model (from step 430), a temperature threshold for the geographical space may be determined at step 440. The temperature threshold may be for identifying a crop planting or production condition. More specifically, in this example, the temperature threshold may be determined by identifying an ambient temperature value that the model indicates has a related value of rainfall which meets a predetermined planting/growth requirement for the crop (e.g., minimum or maximum rainfall).

The method also comprises the step 450 of obtaining information indicative of a detected ambient temperature for the geographic space. For instance, information indicative of a detected ambient temperature for the geographic space can be obtained from a control signal from a user or control system, or from a sensor output signal from a temperature sensor.

The detected ambient temperature is then compared against the temperature threshold in step 460. Based on the result of the comparison, the method either returns to step 450 to obtain a new (e.g., updated) value of the detected ambient temperature, or proceeds to step 470 wherein a signal indicative of a detected crop planting or production for the geographical space is provided to a user. In this way, a user may be instructed when the detected ambient temperature is such that its related rainfall meets the predetermined planting/growth requirement for the crop.

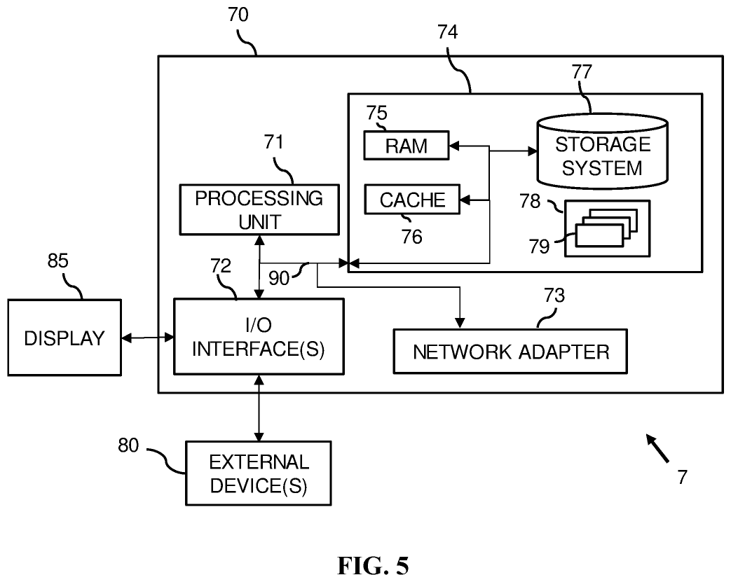

By way of further example, as illustrated in FIG. 5, embodiments may comprise a computer system 70, which may form part of a networked system 7. The components of computer system/server 70 may include, but are not limited to, one or more processing arrangements, for example comprising processors or processing units 71, a system memory 74, and a bus 90 that couples various system components including system memory 74 to processing unit 71.

Bus 90 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 70 typically includes a variety of computer system readable media. Such media may be any available media that is accessible by computer system/server 70, and it includes both volatile and non-volatile media, removable and non-removable media.

System memory 74 can include computer system readable media in the form of volatile memory, such as random access memory (RAM) 75 and/or cache memory 76. Computer system/server 70 may further include other removable/non-removable, volatile/non-volatile computer system storage media. By way of example only, system memory 74 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 90 by one or more data media interfaces. As will be further depicted and described below, system memory 74 may include at least one program product having a set (e.g., at least one) of program modules that are configured to carry out the functions of embodiments of the disclosure.

Program/utility 78, having a set (at least one) of program modules 79, may be stored in memory 74 by way of example, and not limitation, as well as an operating system, one or more application programs, other program modules, and program data. Each of the operating system, one or more application programs, other program modules, and program data or some combination thereof, may include an implementation of a networking environment. Program modules 79 generally carry out the functions and/or methodologies of embodiments of the disclosure as described herein.

Computer system/server 70 may also communicate with one or more external devices 80 such as a keyboard, a pointing device, a display 85, etc.; one or more devices that enable a user to interact with computer system/server 70; and/or any devices (e.g., network card, modem, etc.) that enable computer system/server 70 to communicate with one or more other computing devices. Such communication can occur via Input/Output (I/O) interfaces 72. Still yet, computer system/server 70 can communicate with one or more networks such as a local area network (LAN), a general wide area network (WAN), and/or a public network (e.g., the Internet) via network adapter 73. As depicted, network adapter 73 communicates with the other components of computer system/server 70 via bus 90. It should be understood that although not shown, other hardware and/or software components could be used in conjunction with computer system/server 70. Examples, include, but are not limited to: microcode, device drivers, redundant processing units, external disk drive arrays, RAID systems, tape drives, and data archival storage systems, etc.

In the context of the present application, where embodiments of the present disclosure constitute a method, it should be understood that such a method is a process for execution by a computer (e.g., a computer-implementable method). The various steps of the method therefore reflect various parts of a computer program (e.g., various parts of one or more algorithms)

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a storage class memory (SCM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1.-8. (canceled)

9. A computer program product for crop management in a geographical space, the computer program product comprising a computer readable storage medium having program instructions embodied therewith, the program instructions executable by a processing unit to cause the processing unit to perform a method comprising:
obtaining rainfall information relating to sensed rainfall for a geographic area within a time period, wherein the geographic area includes the geographical space;
obtaining temperature information relating to sensed ambient temperature for the geographic area within the time period;
generating a model based on the obtained rainfall information and temperature information, the model representing a relationship between rainfall and ambient temperature for the geographic area; and
determining a temperature threshold for the geographical space based on the generated model, wherein the temperature threshold is for identifying a crop planting or production condition.

10. The computer program product of claim 9, wherein determining a temperature threshold for the geographic space comprises determining an ambient temperature value that the model indicates has a related value of rainfall which meets a predetermined requirement.

11. The computer program product of claim 9, wherein generating the model comprises:
analyzing the obtained rainfall information and temperature information to determine a correlation between rainfall and ambient temperature for the geographic area;
determining one or more functions for describing the determined correlation; and
generating a model representing a relationship between rainfall and ambient temperature for the geographic area based on the one or more functions.

12. The computer program product of claim 11, wherein analyzing the obtained rainfall information and temperature information comprises processing the obtained rainfall information and temperature information with one or more machine learning algorithms to determine a correlation between rainfall and ambient temperature for the geographic area.

13. A system for crop management in a geographical space, the system comprising:
an interface configured to:
obtain rainfall information relating to sensed rainfall for a geographic area within a time period, wherein the geographic area includes the geographical space; and
obtain temperature information relating to sensed ambient temperature for the geographic area within the time period;
a modeling unit configured to generate a model based on the obtained rainfall information and temperature information, the model representing a relationship between rainfall and ambient temperature for the geographic area; and
a data processing unit configured to determine a temperature threshold for the geographical space based on the generated model, wherein the temperature threshold is for identifying a crop planting or production condition.

14. The system of claim 13, wherein the data processing unit is configured to determine an ambient temperature value that the model indicates has a related value of rainfall which meets a predetermined requirement.

15. The system of claim 13, wherein the modeling unit comprises:
a data analysis unit configured to analyze the obtained rainfall information and temperature information to determine a correlation between rainfall for the geographic area and ambient temperature for the geographic area;
a function generator configured to determine one or more functions for describing the determined correlation between rainfall and ambient temperature for the geographic area;
a model generator configured to generate the model representing a relationship between rainfall and ambient temperature for the geographic area, based on the one or more functions.

16. The system of claim 15, wherein the data analysis unit is configured to process the obtained rainfall information and temperature information with one or more machine learning algorithms to determine a correlation between rainfall and ambient temperature for the geographic area.

17. The system of claim 13, further comprising:
an input interface configured to obtain information indicative of a detected ambient temperature for the geographic space; and
a determination unit configured to detect a crop planting or production condition for the geographical space based on the detected ambient temperature for the geographic space and the temperature threshold.

18. The system of claim 17, further comprising:
an output interface configured to output a signal indicative of the detected crop planting or production for the geographical space.

19. The system of claim 17, wherein the input interface is configured to obtain a control signal from a control system and a sensor output signal from a temperature sensor.

20. The system of claim 13, wherein the geographical space is defined by a boundary of a crop planting.
